(19) United States
(12) Patent Application Publication
(10) Pub. No.: US 2010/0277009 A1
(43) Pub. Date: Nov. 4, 2010

(54) LINEAR VIBRATOR

(76) Inventor: Young Jae JEON, Gyunggi-do (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/538,059

(22) Filed: Aug. 7, 2009

(30) Foreign Application Priority Data
May 4, 2009 (KR) 10-2009-0038906

(51) Int. Cl. H02K 33/02

(52) U.S. Cl. 310/25

(57) ABSTRACT

The present invention provides a linear vibrator which can enhance the assembly accuracy and prevent a vibration unit from coming into direct contact with a coil or a casing. The linear vibrator includes a vibration unit, a casing, a bracket and a spring member. The vibration unit includes a plate yoke which has a weight on an upper surface thereof, and an annular magnet which is provided on the plate yoke and surrounds the weight. The casing has an internal space for receiving the vibration unit therein. The bracket is coupled to the lower end of the casing. A cylindrical coil is provided on the bracket such that the vibration unit linearly vibrates in the cylindrical coil. The spring member is provided in the upper end of the casing to elastically support the vibration unit such that the vibration unit linearly vibrates.

### CROSS REFERENCE TO RELATED APPLICATION

This application claims the benefit of Korean Patent Application No. 10-2009-0038906, filed May 4, 2009, entitled “Linear vibrator”, which is hereby incorporated by reference in its entirety into this application.

### BACKGROUND OF THE INVENTION

1. Technical Field

The present invention relates to a linear vibrator.

2. Description of the Related Art

Generally, portable electronic devices, such as mobile phones, game players, mobile information terminals, etc., have various vibration generating units to prevent noise therefrom from disturbing other people. Particularly, such a vibration generating unit is installed in a cellular phone and used as a mute signal reception indicating unit (including haptic vibration). Recently, in accordance with the trend to provide a small and slim cellular phone, a reduction in the size and an increase in the function of a vibration generating unit installed in the cellular phone are also required.

At present, a vibration generating unit which is one of several signal reception indicating units used in a communication device, such as a cellular phone, converts electric energy into mechanical vibration by the use of a principle of generating electromagnetic force. That is, the vibration generating unit is used as a mute signal reception indicating unit in the cellular phone.

Meanwhile, a method in which mechanical vibration is generated by rotating a rotor having an eccentric weight has been used as a representative example of methods of operating vibration generating units according to prior arts. The rotation of the rotor is implemented by a commutator or brush motor structure which commutates currents through a contact point between the brush and the commutator and then supplies the currents to a coil of the rotor.

However, in the vibration generating unit having this structure, when the brush passes through a gap between segments of the commutator, mechanical friction, electric sparks or abrasion is induced, thus creating impurities, such as black powder, thereby reducing the lifetime of the vibration generating unit. To overcome these problems, a linear vibrator which can produce reliable linear vibration was proposed.

FIG. 1 is a sectional view of a linear vibrator according to a prior art.

As shown in FIG. 1, the linear vibrator 10 according to the prior art includes a casing 40, a bracket 60, a vibration unit 20 and a spring member 80. The casing 40 defines a space therein. The bracket 60 supports thereon a coil 62 which forms a magnetic field using an electric current applied to the coil 62. A damper member 66 is provided on the bracket 60. The vibration unit 20 includes a yoke 24 which has a hollow space therein and is closed on one end thereof, a magnet 26 which is installed in the hollow space of the yoke 24 and provided with a plate yoke 28 attached to the lower surface thereof, and a weight 22 which is fitted over the circumferential surface of the yoke 24. The spring member 80 is coupled to the upper surface of the casing 40 to elastically support the vibration unit 20 such that it linearly vibrates. The yoke 24 includes a disk part 24a and a rim part 24b which is bent downwards from the outer edge of the disk part 24a and extends a predetermined length.

In the linear vibrator 10 having the above-mentioned construction, when power is applied to the coil 62, the vibration unit 20 vibrates upwards and downwards by the spring member 80 due to interaction between a magnetic field which is generated by a magnetic circuit including the cylindrical magnet 26, the plate yoke 28 and the yoke 24, and an electric field generated by the coil 62.

However, in the case of the conventional linear vibrator 10, because the vibration unit 20 is manufactured by assembling the cylindrical weight 22, the yoke 24 and the magnet 26 in a vertical direction, the assembly accuracy and the concentricity are reduced. That is, the magnet 26 is vertically inserted into the hollow space defined by the circumferential inner surface of the yoke 24 and assembled to the yoke 24. In addition, the weight 22 is vertically fitted over the circumferential outer surface of the yoke 24. Hence, the assemblability is reduced, thus increasing the assembly process time.

Furthermore, since the weight 22 which has a relatively high specific gravity and is expensive to manufacture must be formed in a complex shape, it is difficult to machine the weight 22 and a loss of material when machining is increased. In other words, as shown in FIG. 1, an insert hole is formed in the weight 22 such that it can be fitted over the yoke 24 through the insert hole. It is not easy to form the insert hole through the weight 22, and a loss of material corresponding to the size of the insert hole results from the process as well.

In addition, in the prior art, the weight 22 constituting the vibration unit 20 is disposed in the outer portion of the vibration unit 20. Hence, if the vibration unit 20 is moved or rotated in a horizontal direction by external force, the weight 22 may come into direct contact with the casing 40, thus generating noise.

Moreover, because the magnet 26 is disposed at the center of the yoke 24, the area of the portion of the magnet 26 which faces the coil 62 is relatively small. Therefore, the magnetic force is reduced, thus causing undesirable fine vibrations. Thereby, it is difficult to ensure reliable vibration characteristics. If the distance of an air gap AG between the magnet 26 and the coil 62 is reduced to overcome the above-mentioned disadvantage in magnetic force, the magnet 26 or the plate yoke 28 may be brought into contact with the coil 62 while vibrating or by external force, thus damaging the coil 62.

### SUMMARY OF THE INVENTION

The present invention has been made in an effort to provide a linear vibrator which enhances the assembly accuracy, reduces the production cost, and simplifies the manufacturing process.

The present invention provides a linear vibrator which can minimize contact of a vibration unit with a coil or casing.

The present invention provides a linear vibrator which can increase magnetic force generated between the coil and a magnet.

In a linear vibrator according to an embodiment of the present invention, a vibration unit has a plate yoke provided with a weight on an upper surface thereof, and an annular magnet provided on the plate yoke. The annular magnet surrounds the weight. A casing has an internal space and receives the vibration unit therein. A bracket is coupled to a lower end of the casing. A cylindrical coil is provided on the bracket such that the vibration unit linearly vibrates in the cylindrical coil. A spring member is provided in an upper end of the casing to elastically support the vibration unit such that the vibration unit linearly vibrates.

A support protrusion may be provided on the bracket to support the cylindrical coil.

The plate yoke may include a disk part, and a rim part bent upwards from an outer edge of the disk part and extending a predetermined length.

The cylindrical coil may be attached to the bracket using a thermosetting hot melt tape.

In the linear vibrator, a damper member may be further provided on the bracket below the vibration unit to prevent the vibration unit from coming into contact with the bracket when the vibration unit linearly vibrates.

The spring member may comprise a plate spring member fastened to the upper end of the casing. The weight or the annular magnet may be coupled to the plate spring member.

A magnetic fluid may be applied to an upper surface of the spring member at a position corresponding to the annular magnet. The magnetic fluid may be set in position by a leakage flux of the annular magnet.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a sectional view of a linear vibrator according to a prior art;

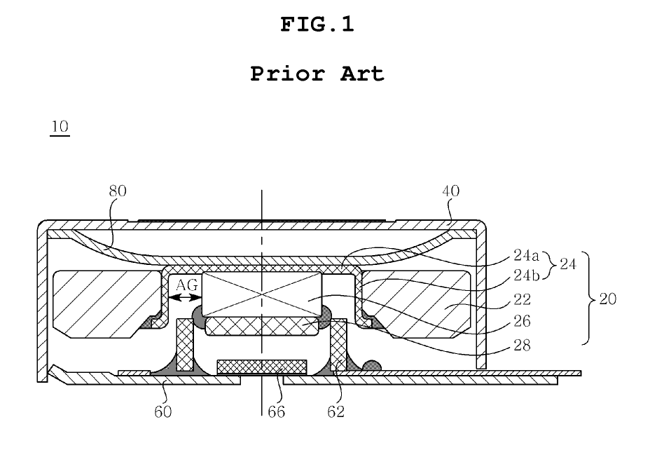

FIG. 2 is an exploded perspective view of the linear vibrator of FIG. 1;

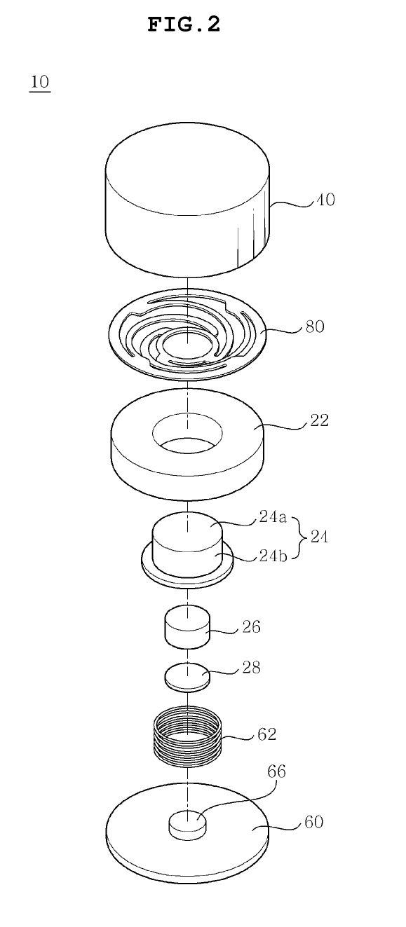

FIG. 3 is a sectional view of a linear vibrator, according to an embodiment of the present invention; and

FIG. 4 is an exploded perspective view of the linear vibrator of FIG. 3.

### DESCRIPTION OF THE PREFERRED EMBODIMENTS

Reference now should be made to the drawings, in which the same reference numerals are used throughout the different drawings to designate the same or similar components. In the following description, when it is determined that the detailed description for the conventional function and conventional structure confuses the gist of the present invention, the description may be omitted. Furthermore, the terms and words used in the specification and claims are not necessarily limited to typical or dictionary meanings, but must be understood to indicate concepts selected by the inventor as the best method of illustrating the present invention, and must be interpreted as having meanings and concepts adapted to the scope and sprit of the present invention for understanding the technology of the present invention.

Hereinafter, an embodiment of the present invention will be described in detail with reference to the attached drawings.

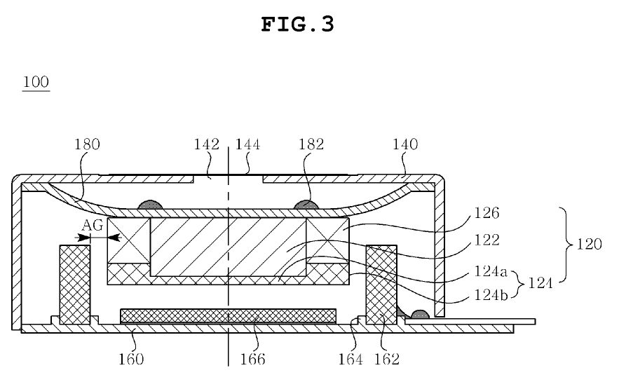

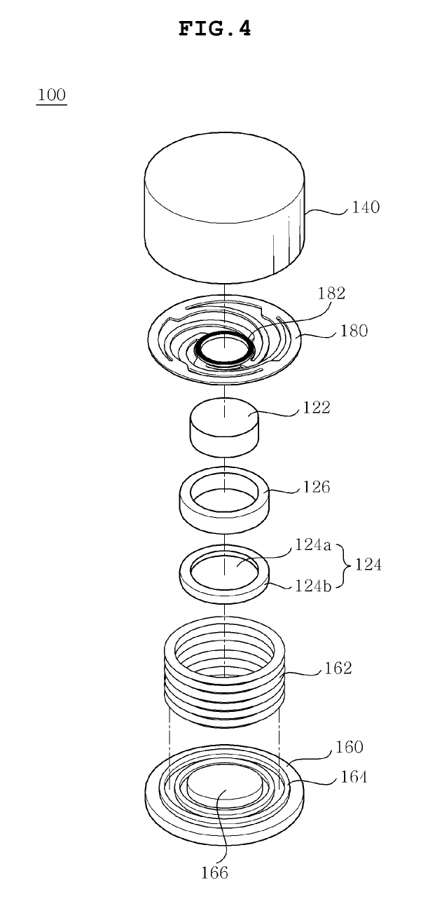

FIG. 3 is a sectional view of a linear vibrator 100, according to the embodiment of the present invention. FIG. 4 is an exploded perspective view of the linear vibrator 100 of FIG. 3. The linear vibrator 100 according to the embodiment of the present invention will be described with reference to these drawings.

As shown in FIGS. 3 and 4, the linear vibrator 100 includes a vibration unit 120, a casing 140, a bracket 160 and a spring member 180.

The vibration unit 120 linearly vibrates and includes a plate yoke 124, a weight 122 and an annular magnet 126. Here, the vibration unit 120 is manufactured in such a way that the weight 122 is disposed at the center of the vibration unit 120 and is inserted into a hollow space of the plate yoke 124 and the annular magnet 126 is thereafter fitted over the circumferential outer surface of the weight 122. Therefore, the assembly accuracy of the vibration unit 120 can be improved, compared to the vibration unit of the prior art.

The plate yoke 124 supports the weight 122 and the annular magnet 126 thereon and makes the formation of the magnetic flux of the annular magnet 126 smooth. The plate yoke 124 has therein the hollow space which is open on one end thereof and closed on the other end, that is, it has a hollow cylindrical shape which is open on the upper end thereof and closed on the lower end thereof.

In detail, the plate yoke 124 includes a disk part 124a and a rim part 124b which is bent upwards from the outer edge of the disk part 124a and extends a predetermined length. The inner surface of the disk part 124a and the circumferential inner surface of the rim part 124b form the hollow space into which the weight 122 is inserted. The rim part 124b supports a portion of the circumferential outer surface of the weight 122. The annular magnet 126 is installed on the upper end of the rim part 124b.

The weight 122 provides a predetermined weight to the vibration unit 120 to realize linear vibration and is inserted into the hollow space of the plate yoke 124.

The weight 122 is made of non-magnetic material, for example, tungsten (W), to prevent it from being affected by the magnetic force of the annular magnet 126.

In the present invention, because the weight 122 is inserted into the central portion of the plate yoke 124, it is unnecessary to form a separate insert hole in the weight 122, unlike the prior art in which the weight is fitted over the yoke through the insert hole formed in the weight. Therefore, a process of manufacturing the weight 122 can be simplified, and a weight loss of the weight 122 can be minimized.

Furthermore, unlike the prior art, since the weight 122 is disposed at the center in the vibration unit 120, even if the vibration unit 120 is moved in the horizontal direction or rotated by external force, the vibration unit, in particular, the weight 122 having a predetermined weight, can be prevented from being brought into direct contact with the casing 140.

The annular magnet 126 generates a predetermined intensity of magnetic field to linearly vibrate the vibration unit 120 through interaction with the coil 162. The annular magnet 126 is provided on the plate yoke 124 and surrounds the weight 122.

Furthermore, the annular magnet 126 is a permanent magnet which is magnetized in the vertical direction to have different poles in the upper and lower parts thereof and generates a predetermined intensity of magnetic force. The annular magnet 126 has therein an insert hole into which the weight 122 is inserted. Here, because the annular magnet 126 can be easily manufactured or purchased, the present invention has an advantage in production cost and manufacturing, compared to the case where the weight 122 made of material having a relatively high specific gravity is manufactured in a ring shape.

In addition, the present invention is constructed such that the annular magnet 126 surrounds the weight 122 that is disposed at the center of the vibration unit 120. Therefore, compared to the construction of the vibration unit according to the prior art, the surface area of the annular magnet 126, particularly the surface area of a portion facing the coil 162, is increased. Thereby, the magnetic force can be increased, so that the reliable operation of the linear vibrator 100 can be ensured. As well, undesirable fine vibration attributable to external force can be prevented.

The casing 140 defines an internal space for installation of elements including the vibration unit 120 therein. The casing 140 has a structure which is open on the lower end thereof. The open lower end of the casing 140 is covered with the bracket 160.

At least one injection hole 142 is formed through the upper surface of the casing 140. Magnetic fluid 182 is applied through the injection hole 142 to the spring member 180 provided in the casing 140. After the application of the magnetic fluid 182 has been completed, the upper surface of the casing 140 is sealed, for example, by tape 144 to prevent leakage of the magnetic fluid 182.

The bracket 160 is coupled to the lower end of the casing 140 to seal the space in the casing 140. The coil 162 for generating vibration is provided on the bracket 160.

The bracket 160 includes a substrate (not shown) having terminals which are electrically connected to the coil 162 to supply power to the coil 162.

The coil 162 generates a predetermined intensity of electric field when external power is applied to the terminals of the bracket 160. The lower end of the coil 162 is bonded to the upper surface of the bracket 160 using bonding agent, preferably, a thermosetting hot melt tape.

Here, the coil 162 has a cylindrical shape which has a hollow space in which the vibration unit 120 reciprocates, that is, linearly vibrates. The coil 162 is attached to the bracket 160 at a predetermined position such that an appropriate air gap AG is defined between the circumferential outer surface of the annular magnet 126 and the circumferential inner surface of the coil 162 to make the interaction between the magnetic field generated from the annular magnet 126 and the electric field generated from the coil 162 smooth. As mentioned above, in the present invention, because a surface area of a portion of the annular magnet 126 which faces the coil 162 is increased and magnetic force is thus enhanced, the size of the air gap AG can be increased, compared to the prior art. Therefore, the present invention can minimize a problem of damage to the coil 162 attributable to direct contact being made between the coil 162 and the vibration unit 120 which linearly vibrates.

A damper member 166 may be provided on the bracket 160 to absorb impact and prevent the vibration unit 120 from coming into direct contact with the bracket 160. In detail, the damper member 166 which is provided on the bracket 160 is disposed in the hollow space of the coil 162 below the plate yoke 124 to prevent the annular magnet 126 from coming into contact with the bracket 160 when it reciprocates in the hollow space of the coil 162 due to linear vibration. Here, various kinds of materials, for example, rubber, polypropylene, etc., can be used as the material of the damper member 166, if it can satisfactorily absorb impact.

In the embodiment, protrusions 164 for supporting the coil 162 are provided on the bracket 160. The protrusions 164 may be integrally formed in the bracket 160 through a pressing process. The coil 162 is fitted between the protrusions 164, thus enhancing the assemblability.

The spring member 180 elastically supports the vibration unit 120 to ensure linear motion of the vibration unit 120. For example, the spring member 180 comprises a plate spring member which is attached at the outer edge thereof to the inner surface of the upper end of the casing 140 while the central portion thereof is spaced apart from the upper plate of the casing 140.

It is preferable that the magnetic fluid 182 functioning as a damping member be applied to the upper surface of the spring member 180. The magnetic fluid 182 has the characteristic that it is collected by the magnetic flux of the annular magnet 126. Hence, when the magnetic fluid 182 is applied to the upper surface of the plate spring member 180, it is arranged in a ring shape by leakage flux of the annular magnet 126. The magnetic fluid 182 prevents the vibration unit 120 from coming into direct contact with the casing 140 when it vibrates upwards and downwards, thus preventing noise which may occur due to contact between the vibration unit 120 and the casing 140, and absorbing impact due to the contact.

In detail, the magnetic fluid 182 is formed in such a way that magnetic powder is stably and evenly dispersed in liquid to have a colloidal shape and a surface active agent is added to the liquid to prevent deposition or agglutination of the magnetic powder attributable to the gravity or magnetic field. For example, magnetic fluid formed by dispersing triiron tetroxide or iron-cobalt alloy particles in oil or water is used, and, recently, magnetic fluid formed by dispersing cobalt in toluene is used. Such magnetic powder is an ultrafine particle powder ranging from 0.01 μm to 0.02 μm and moves under Brownian motion that is one of the specific characteristics of ultrafine particles. In addition, the magnetic fluid is characterized in that even if an external magnetic field, gravity, centrifugal force, etc. is applied thereto, the density of magnetic powder particles in fluid is maintained constant.

As described above, in the present invention, a weight is disposed at the center of a vibration unit and is inserted into a hollow space of a plate yoke and an annular magnet is thereafter fitted over the circumferential outer surface of the weight. Therefore, the assembly accuracy of the vibration unit can be improved.

Furthermore, because it is unnecessary to form a separate insert hole in the weight, a process of manufacturing the weight can be simplified. A loss of material due to the formation of the insert hole can be prevented, thus reducing the production cost, and further facilitating the manufacture of the linear vibrator.

In addition, the weight is provided on the center of the plate yoke such that it is spaced apart from the casing, thus preventing the weight from coming into direct contact with the casing.

As well, the present invention is constructed such that the annular magnet surrounds the weight. Hence, the surface area of the annular magnet is increased and, particularly, the surface area of a portion facing the coil is increased. Thereby, the magnetic force can be increased, so that Undesirable fine vibration is prevented and the reliable operation of the linear vibrator can be ensured. The size of the air gap between the coil and the vibration unit is increased, thus minimizing direct contact between the coil and the vibration unit.

Moreover, protrusions are provided on a bracket coupled to the casing, so that the assemblability and assembly accuracy of the coil can be increased.

In the present invention, the vibration unit is manufactured in such a way that the weight is disposed at the center in the annular magnet and they are provided on the plate yoke. Therefore, the present invention does not require a separate yoke which has been used in the prior art, thus reducing the number of elements, thereby reducing the number of manufacturing processes.

Furthermore, the size and weight of the weight which is provided on the center of the plate yoke are reduced, so that the linear vibrator of the present invention can be optimized as a low vibration generating means based on the haptic technology.

Although the embodiment of the present invention has been disclosed for illustrative purposes, it will be appreciated that the linear vibrator of the invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A linear vibrator, comprising:
a vibration unit, having a plate yoke provided with a weight on an upper surface thereof, and an annular magnet provided on the plate yoke, the annular magnet surrounding the weight;
a casing having an internal space and receiving the vibration unit therein;
a bracket coupled to a lower end of the casing, with a cylindrical coil provided on the bracket such that the vibration unit linearly vibrates in the cylindrical coil; and
a spring member provided in an upper end of the casing to elastically support the vibration unit such that the vibration unit linearly vibrates.

2. The linear vibrator as set forth in claim 1, wherein a support protrusion is provided on the bracket to support the cylindrical coil.

3. The linear vibrator as set forth in claim 1, wherein the plate yoke comprises a disk part, and a rim part bent upwards from an outer edge of the disk part and extending a predetermined length.

4. The linear vibrator as set forth in claim 1, wherein the cylindrical coil is attached to the bracket using a thermosetting hot melt tape.

5. The linear vibrator as set forth in claim 1, further comprising:
a damper member provided on the bracket below the vibration unit to prevent the vibration unit from coming into contact with the bracket when the vibration unit linearly vibrates.

6. The linear vibrator as set forth in claim 1, wherein
the spring member comprises a plate spring member fastened to the upper end of the casing, and
the weight or the annular magnet is coupled to the plate spring member.

7. The linear vibrator as set forth in claim 1, wherein a magnetic fluid is applied to an upper surface of the spring member at a position corresponding to the annular magnet, the magnetic fluid being set in position by a leakage flux of the annular magnet.
